(19) United States
(12) Patent Application Publication
(10) Pub. No.: US 2019/0012183 A1
(43) Pub. Date: Jan. 10, 2019

(54) METHOD OF PROVIDING SOFTWARE DEVELOPMENT SERVICES

(71) Applicant: Ralph SAUNDERS, Springfield, VA (US)

(72) Inventor: Ralph SAUNDERS, Springfield, VA (US)

(21) Appl. No.: 16/128,823

(22) Filed: Sep. 12, 2018

Related U.S. Application Data
(63) Continuation-in-part of application No. 13/486,117, filed on Jun. 1, 2012.
Application No. 13/486,117 is a continuation-in-part of application No. 11/702,196, filed on Feb. 5, 2007, now abandoned.
(60) Provisional application No. 60/765,204, filed on Feb. 6, 2006.

(51) Int. Cl. G06F 9/448; G06F 8/10; G06F 8/77; G06F 11/36

(52) U.S. Cl. CPC G06F 9/448; G06F 11/3604; G06F 8/77; G06F 8/10

(57) ABSTRACT

A method for providing fully automated software development services using only preexisting proprietary software to perform the software development, thus eliminating the human programmer from the software development process. The software, running on network accessible computers, receives a set of requirements that defines for it the nature of some custom software that it should develop/create. Based on the input, the preexisting proprietary software then develops the custom software source code as “work made for hire”, compiles the code, installs the compiled code onto one of its own computers and runs tests against the software to prove that the developed software satisfies the supplied requirements. The results of the test are presented to the customer and, if the test results are approved by the customer, the developed custom software or source code is then made available for downloading by the customer after they have paid for the software development services used to create that software. The custom software or source code is considered “work made for hire” and the customer who commissioned the work has the exclusive intellectual property rights to the developed software.

### CROSS REFERENCE TO RELATED APPLICATIONS

This application is a continuation-in-part of U.S. patent application Ser. No. 13/486,117, pending, filed Jun. 1, 2012, which is a continuation-in-part of U.S. patent application Ser. No. 11/702,196, filed Feb. 5, 2007, which claims the benefit and priority of Provisional Patent Application No. 60/765,204 filed on Feb. 6, 2006, the entire contents of each of which are hereby incorporated by reference in this application.

### BACKGROUND OF THE INVENTION

### 1. Field of the Invention

The present invention relates to a method of providing software development services to a customer using only preexisting proprietary software to provide the software development services and, more particularly, to such a method wherein the services can be provided online to the customer at a computer work station or the like, without the use of human software developers.

### 2. Description of the Background Art

Up to the present time, software development services have been provided by human software developers to customers using one of two methods, or a combination of the two methods. The first method is to provide temporary software development personnel who physically reside at a customer's office in order to create the source code, build scripts and other files needed to compile, run and test and otherwise use the desired software, organized into what is called a source code tree. These software development personnel receive the requirements that are needed to create the desired software, and other necessary files, through several different methods, including but not limited to, face to face meetings with the customer, through phone conversations with the customer and through emails exchanged with the customer. The software development personnel then use the information contained in those requirements to design a solution and create the source code that fulfills those requirements.

The second method is to provide software development personnel who do not physically reside at the customer's office, but instead physically reside at another location that is separate from any facilities owned or leased by the customer in order to create the desired software. As in the previous method, software requirements are received using several methods, including but not limited to, face to face meetings with the customer, phone conversations with the customer and through emails exchanged with the customer. Once the requirements have been received, the software developer uses the information in those requirements to create the desired source code.

With each of these methods, at the end of the software development process, the source code that has been developed is compiled and tests are run to make sure that the source code meets the requirements that were collected at the beginning of the software development process.

Both of these approaches to software development require the use of human programmers to develop the desired software, and because humans are involved in the software development process they add risk to that development process in three ways. The first way humans add risk to the software development process is due to the fact that it takes many months for a human software developer to create a piece of software and therefore it also takes many months before the customer can see a functioning version of the software that is being developed. This introduces a time based risk into the process, because in the software industry “time to market” is one factor in software development that can impact a products success, specifically in the case where a competitor is able to shorten their “time to market” and sell their competing product before “our” product is ready to be sold.

A second risk introduced by the current methods of software development is because many software contracts require progress payments, usually based on agreed upon milestones, so by the time the customer gets to see function software, they have already paid out a significant amount of money and if the developed software does not work as desired, the time and money spent on developing that software will be lost. This loss could, in some cases, end up being large enough to cause the project to be delivered late or not at all, and this fact adds a large amount of risk to the project. Even if the contract calls for payment at the end of the software development, after acceptance by the customer, only the monetary based risk associated with the current form of software development is reduced, but the time base risk still exists.

The third way humans introduce risk to the software development process is because of the potential for human error while developing software. Humans are less consistent and less accurate than computer programs when preforming the same task, which is how “human error” gets introduced into a development project. Most of the time human error is caught in the testing of the software, which can prolong testing and delay the release of the software, but sometimes it is not caught until after the software has been released which can be difficult and costly to fix. However, since the present invention (called Virtual Software Developer) is a program that can reliably and consistently perform the same task over and over with the same precision, accuracy, and outcome every time, it cannot not introduce random variations into the source code like a human can, so Virtual Software Developer will not introduce “human error” into the software development process and that fact will also lower the risk associated with the software development project.

The new and improved method of the present invention eliminates the above identified risks in addition to reducing the cost associated with developing custom software, by eliminating the human developer from the software development process and only using proprietary software to develop the custom software. Using only software to develop custom software is a novel, non-obvious improvement over the current approach to developing software that greatly reduces the amount of time it takes to create working software from weeks, months or even years, to less than an hour. This reduction in time, in combination with the precision and accuracy of Virtual Software Developer, greatly reduces the risks associated with developing the software and provides many benefits to the customer.

Referring to another aspect of the method of the present invention, there are four different approaches that can be used to create new software which are listed below:

1) To create a design that calls for using custom source code, created by a developer specifically for a given end user and either licensed to that user or developed as “work made for hire” for that user, to implement the business logic, services and other functionality identified in the requirements provided by that end user;

2) To create a design that calls for using custom source code created by a developer and either licensed to that user or developed as “work made for hire” for that user to implement the business logic identified in the requirements along with using preexisting software frameworks to provide services and other functionality called out in the requirements provided by the end user;

3) To use preexisting software engineering modules and, either no custom source code or custom source code that is licensed for use by the customer, to implement the business logic, services and other functionality identified in the end user's requirements (e.g., see Bellagamba, U.S. Publ. 2002/0188927); or

4) To use preexisting software applications and, either no custom source code or custom source code that is licensed for use by the customer, to implement/provide the business logic, services and other functionality identified in the end user's requirements (e.g., see Bilange, U.S. Publ. 2004/0093595).

Each of these approaches can be used to produce a given software product for a customer, but each of these approaches will provide the customer with a different level of rights to the intellectual property contained in the software that was created. The reason for this is due to the differences between how the law views intellectual property rights with respect to custom source code, preexisting software frameworks, preexisting software engineering modules and preexisting software applications. Preexisting software engineering modules and preexisting software applications are either licensed for use by the end user or they are in the public domain and available for anyone to use, and provide no intellectual property rights to the end user. The same is true for preexisting software frameworks, because these frameworks do not implement any business logic and only provide generic services to any application that uses them. Custom source code, on the other hand, is the intellectual property of the developer who created that source code unless the source code was developed as a “work made for hire” as defined in section 101 of Title 17 of the U.S. Code. Source code that was developed as “work made for hire” becomes the exclusive property of the customer who commissioned the work, providing that customer with the full intellectual property rights to that custom source code.

In addition, licensed software may, or may not, allow the end user access to the source code that was used to create the custom software. If the customer is not allowed access to the source code, they will not be able to use the source code to trouble shoot problems that might occur with the software product long after the development of the software product has ended. Without access to the source code, the end user will also not be able to enhance its software product by adding to, or changing, the source code that was used to create the software engineering module, nor will it be able to fix bugs in the software engineering module that might adversely affect the developed software. Instead, the end user will be reliant on the provider/owner of the software engineering module to make the enhancement or bug fix that the end user needs. Even if the user has access to the source code, the license associated with the source code may impose restrictions on the use and modification of that software, a condition that would not exist if the business logic the engineering module implements were implemented using custom source code that was developed as “work made for hire”.

### SUMMARY OF THE INVENTION

The invention, called Virtual Software Developer, is preexisting proprietary software that completely replaces the human software developer in the software development process. Removing the human software developer from the software development process creates a revolutionary new way to provide software development services to a customer. This new method provides the customer with several very significant improvements over the current method of using human software developers to develop custom software, with each improvement providing several benefits to the customer.

The first improvement that Virtual Software Developer provides over the current method of software development is that Virtual Software Developer can produce the desired custom software much faster than a human can. To describe just how much faster Virtual Software Developer is, a program that would normally take a human software developer 6 months to develop and test, can be developed and tested by Virtual Software Developer in less than an hour and without any human intervention. This drastic reduction in development time virtually eliminates the time based risks that are currently associated with software development because the customer waits minutes instead of weeks or months in order to see the working software and getting to testing it.

This drastic reduction in time provides the customer with several additional benefits. One of the benefits is that the customer only has to pay for the software after the custom software has been developed and tested, and they have approved the test results. This is in direct contrast to the current method of using humans where the customer pays portions of the total cost of developing the software in “installments” as milestones are met throughout the software development process. This means that under the existing method of software development the customer does not get to see the finished software until after they have already paid a significant amount of money to the developer, creating a significant amount of risk for the customer if the software does not end up meeting their needs. Virtual Software Developer, however, develops software so fast that it completely eliminates that monetary and time based risk from the software development process and in addition, Virtual Software Developer can offer the software development services to the customer at a much lower cost that the existing method of software development, which is a second benefit that the reduction in time from using Virtual Software Developer provides to the customer.

A third benefit to the customer from this drastic reduction in time is that using Virtual Software Developer can drastically reduce the customers “time to market” over the current method of using a human software developer. What this means is that if the customer is going to re-sell the software as a product, or use the software as part of another product, the amount of development/manufacturing time required before the product can be sold will be greatly reduced by using Virtual Software Developer, which will give that customer a distinct advantage over their competition.

The second improvement Virtual Software Developer provides to the software development process is the removal of “human error” from the process. This means that the resulting source code will not contain any random errors than are typically introduced by human developers during the software development process.

In certain examples, in accordance with a method of the present invention, the proprietary software known as Virtual Software Developer has been loaded onto, and is running on, a website and other network accessible computers that the customer can access with a computer to provide, online, the requirements for the source code (i.e. software) that is to be developed for the customer. Virtual Software Developer then develops, compiles and installs the custom source code on one of its own computers for testing and review by the customer. Once the customer is satisfied with the custom source code that has been developed, the customer is charged for the software development services used and the source code is made available for downloading onto the customer's computer.

Upon receipt of the requirements, the existing (e.g., already installed and ready to operate as described herein) proprietary software, without the intervention of a human, performs the following steps to create the desired custom source code:

1) The software (e.g., the Virtual Software Developer) uses techniques known to Virtual Software Developer to examine and analyze the supplied requirements for the desired custom software. Based on the software's analysis of the requirements, the software decides on an appropriate system design for the desired custom software.

2) Virtual Software Developer then creates a directory hierarchy called a software source code tree (e.g., a layout for files and directories needed for developing software). Virtual Software Developer then uses techniques known to Virtual Software Developer to create the build and configuration files needed to compile the finished software. Virtual Software Developer then populates the newly created source code tree with those build and configuration files.

3) The next step Virtual Software Developer takes is to create the custom source code that implements the design the software decided on in Step 1. The custom source satisfies the requirements for the custom software that were also received in Step 1, as “work made for hire” in accordance with Section 101 of the Copyright Act (title 17 of the U.S. Code). The custom source code is created by a process that uses the analysis that was done on the requirements in Step 1, along with the design that was decided upon by Virtual Software Developer in Step 2 and techniques known to Virtual Software Developer, to create a set of source code files. Virtual Software Developer then populates the source code tree created in Step 2 with the source code files created in this step.

4) Virtual Software Developer's next step is to create the tests for the custom source code it just created that prove that the software meets the requirements that were provided in Step 1. This is done in a manner similar to the way the custom source code was developed, by using the analysis that was done on the requirements in Step 1, along with the design that was decided upon by Virtual Software Developer in Step 2 and

techniques to create a set of test source code files that will test the custom software to ensure it satisfies the requirements supplied in Step 1. Virtual Software Developer then populates the source code tree with the test source code files that were created in this step.

5) Next Virtual Software Developer uses the build and configuration files it populated the source code tree with in Step 1 to compile the custom source code and the test source code that Virtual Software Developer populated the source code tree with in Step 3 and Step 4.

6) After Virtual Software Developer has compiled the custom software and the test source code, the proprietary software will, based on the design of the software, stage the custom software and run the tests, saving the output and results of the test run.

7) Virtual Software Developer then packages up the source tree along with the test run output and results and places that package in a location suitable for downloading by a customer.

The term “software developer” used herein is intended to refer to the computer program called Virtual Software Developer and does not refer to a human software developer, unless the term is prefixed with the word “human”. Accordingly, the custom source code developed by Virtual Software Developer is software that is created from a set of requirements provided by the customer and is considered “work made for hire”. Under Section 101 of the Copyright Act (title 17 of the U.S. Code), custom source code is considered the exclusive intellectual property of the developer of the source code (i.e. the author), unless the custom source code has been developed as “work made for hire”, in which case the developed source code becomes the exclusive intellectual property of the customer for whom the source code was created. Because the source code generated by Virtual Software Developer is “work made for hire”, the custom source code created by Virtual Software Developer provides the customer full intellectual property rights with no restrictions of any kind.

A software product developed for a customer where the customer has exclusive intellectual property rights to that software is more valuable to that customer than a functionally similar software product that the customer does not own the intellectual property rights to.

A Virtual Software Developer is offered to the public as a fully automated, network accessible software development service that uses no humans to create software. In certain examples, it runs on a web site that provides the usual type of functionality, such as customer management, account management, including functionality for the collecting of fees from a customer for the use of Virtual Software Developer's software development services, etc.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is an overview of the system according to certain examples;

FIG. 2 is a diagram of a Main Control Component according to certain examples;

FIG. 3 is a diagram of a Network Component according to certain examples;

FIG. 4 is a diagram of a Design Component according to certain examples;

FIG. 5 is a diagram of a File System Component according to certain examples;

FIG. 6 is a diagram of a Source Code Generation Component according to certain examples;

FIG. 7 is a diagram of a Source Code Testing Component according to certain examples;

FIG. 8 is a diagram of a Acceptance and Payment Component according to certain examples; and

FIG. 9 is a diagram of a Product Delivery Component according to certain examples.

### DETAILED DESCRIPTION OF THE INVENTION

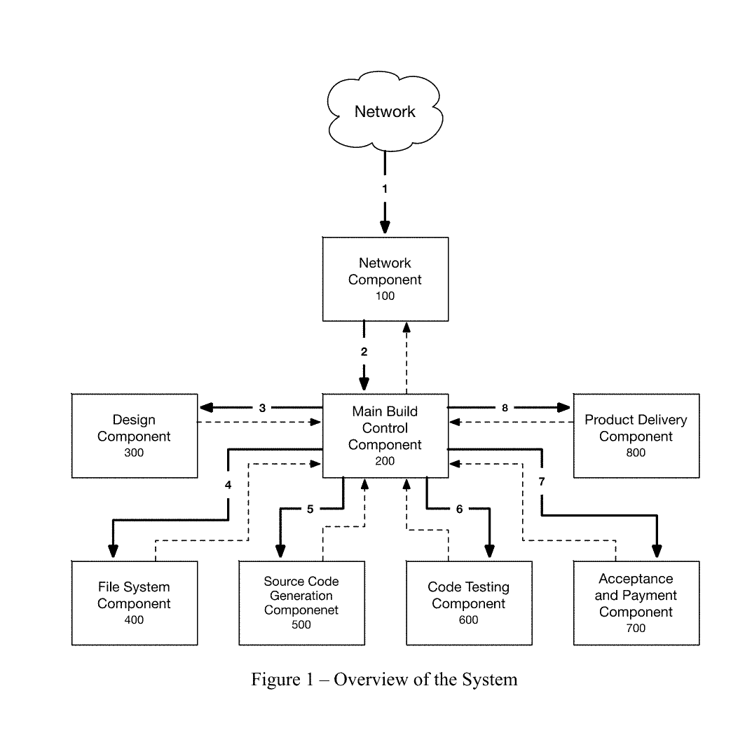

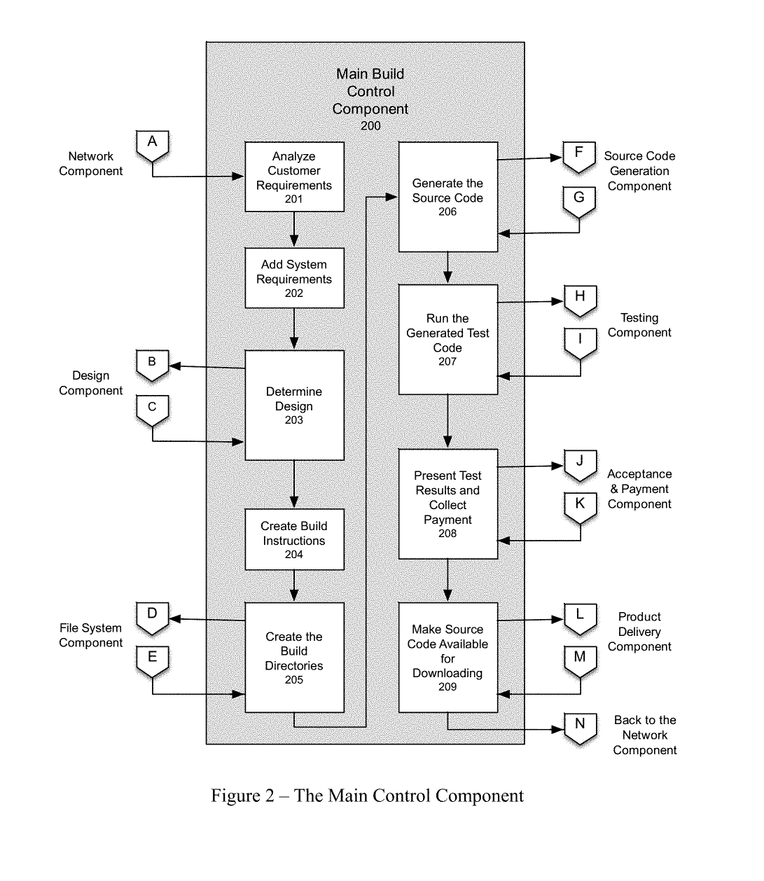

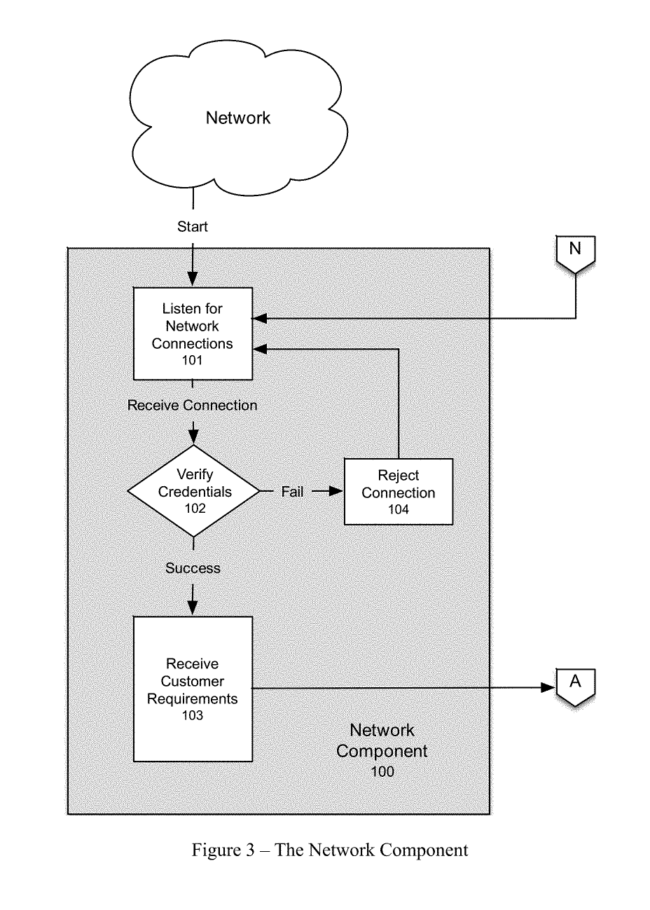

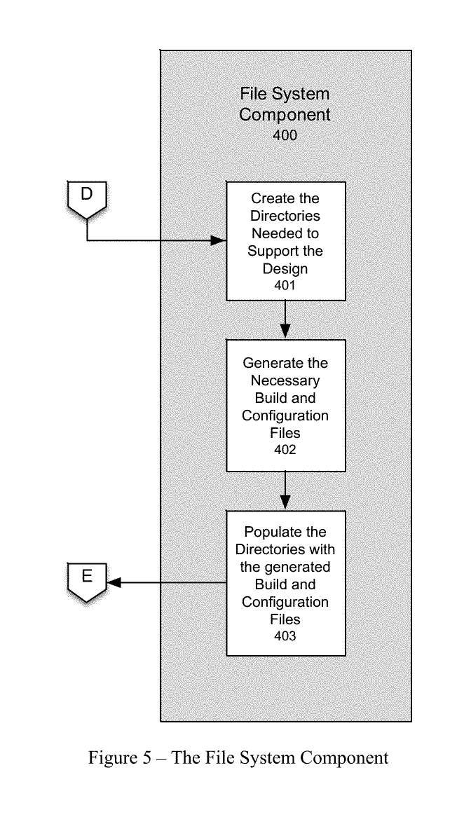

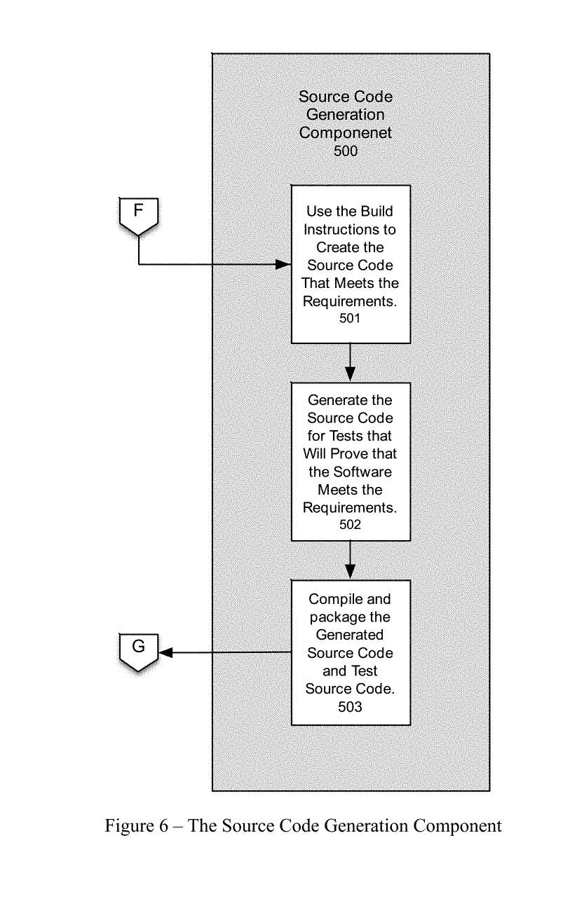

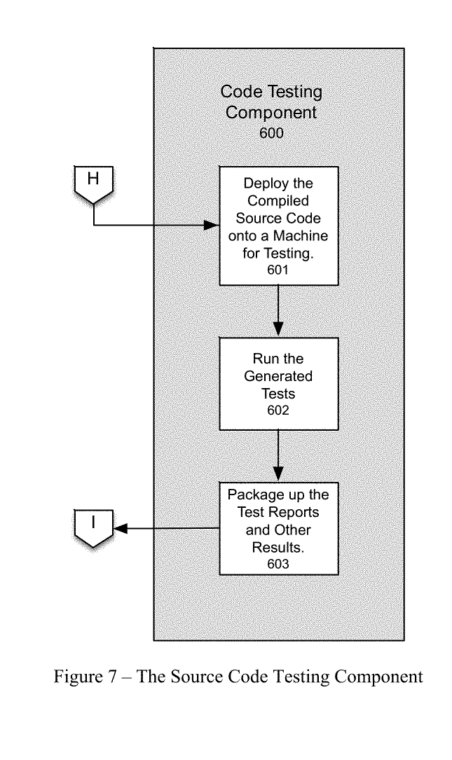

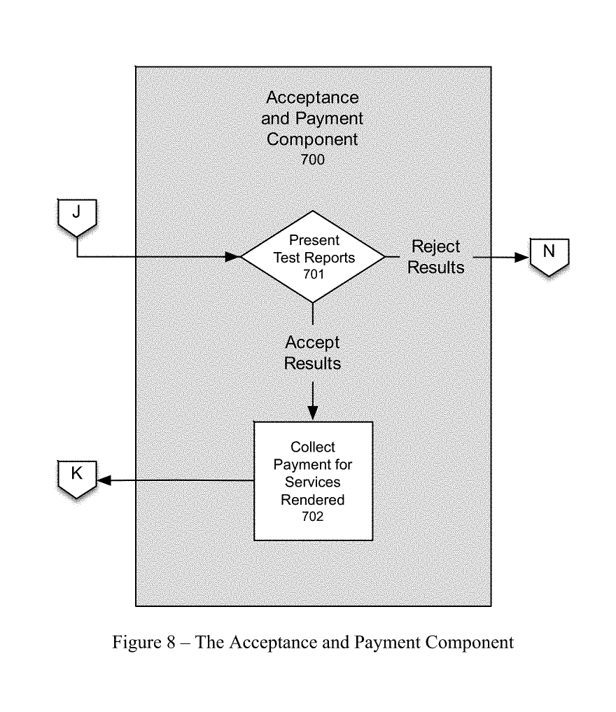

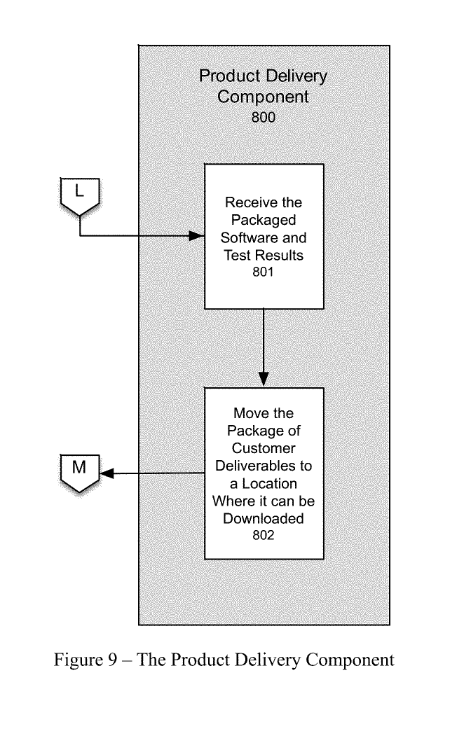

Virtual Software Developer provides software development services in a fully automated way, completely replacing the human software developer and creating custom software on it's own, by following several steps. Those steps are depicted in FIG. 1 through FIG. 9, which are included above. FIG. 1 provides a graphical overview of the invention, showing at a high level the different components and how those components interact with each other. Solid lines in FIG. 1 depict calls to a component and dashed lines in the drawing depict the return from those calls. FIGS. 2 through 9, along with the narrative that follows, provide further detail on all of the components that make up Virtual Software Developer and how they interact with each other.

Virtual Software Developer's entire development process is controlled by the master build component 200, which is responsible for analyzing the requirements provided by the customer as input to the development process through the network component 100, and for managing the software development process, without any human intervention at all. That software development process being comprised of the following steps:

The Virtual Software Developer's initial state is with the network component 100 listening for incoming connections on a network interface at 101 and for the rest of the components that make up the invention to be in an idle state. Virtual Software Developer's software development process begins when the network component receives a connection request at 101 and verifies the credentials of the customer at 102. If the customer credentials pass verification, the network component receives the requirements at 103 from the customer for custom software that is to be built by Virtual Software Developer. If the customer credentials do not pass verification, then Virtual software Developer rejects the connection attempt at 104 and returns to listening for new connections at 101.

When the network component 100 of Virtual Software Developer has received the customer's requirements for custom software, it passes those requirements to the master build component 200 so that the master build component can analyze the requirements at 201 and then add any additional requirements and information to the submitted requirements that the master build component determines is necessary in order to build the desired software at 202.

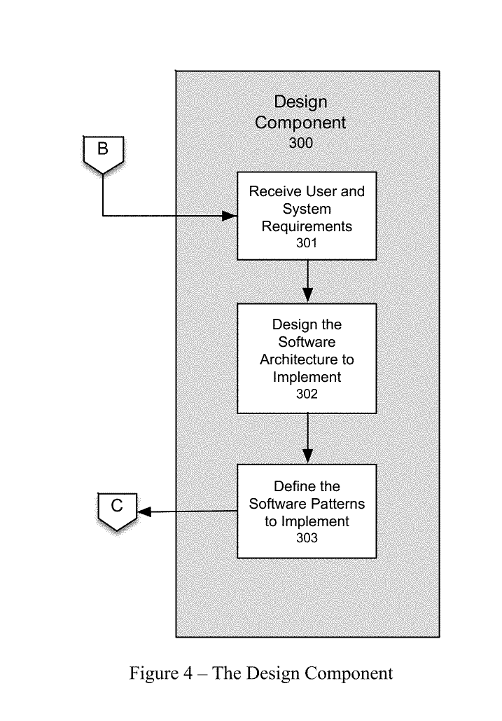

At 203, the master build component 200 then passes the enhanced requirements to the design component at 301 300 shown in FIG. 4 so that the design component 300 can evaluate them and decide on a software design at 302 that is appropriate for the custom software being built. Based on the resulting design, the component then identifies the software patterns that need to be implemented at 303 based on that design and passes the design and pattern information back to the master build component 200.

The master build component takes the requirements, and the design and software pattern information from the previous step, and produces a comprehensive set of build instructions for creating the desired custom software at 204. These build instructions are then used throughout the remainder of the development process.

At 205, the master build component 200 then passes the build instructions to the file system component 400 to create the hierarchy of directories and subdirectories that will hold the completed custom source code at 401. Once the directory hierarchy has been created, the file system component creates the build and configuration files at 402 that will be used to compile and package the custom software after it has been generated. The file system component then populates the directories it just created with the newly created build and configuration files at 403, returning, at 205, control back to the master build component 200.

At 206, the next step in the process is for the master build component 200 to pass the build instructions to the source code generation component 500 so it can generate the desired custom source code at 501. The source code generation component also generates source code for a set of tests at 502 that, when run, will prove that the generated software meets the original requirements provided by the customer. It should be noted that the source code generation component 500 is entirely automated and requires no human intervention to create the generated source code discussed herein. It should be noted that the source code that is generated for the customer as discussed herein is being created as “work made for hire” in accordance with Section 101 of the Copyright Act (title 17 of the U.S. Code), leaving the customer with the full intellectual property rights to the generated software.

The source code generation component 500 then compiles and packages all the source code it just generated at 503, and passes that compiled and packaged code back. at 206, to the master build component 200.

Next at 207, the master build component 200 passes the compiled and packaged code to the code testing component 600. The code testing component takes the packaged software and deploys it onto an internal, non-customer machine along with the generated test code at 601. The component then runs the generated test code against the generated and compiled software at 602, saving all relevant output from running the tests. The test results are then packaged up by the code testing component at 603 and then passed back to the master build component 200.

At 208, the master build component 200 passes the test results to the acceptance and payment component 700, where the test results are presented to the customer for their final acceptance at 701. If the customer does not like the test results, they can reject them, and the acceptance and payment component will pass control back to the network component to listen for new connections at 101. The customer can then adjust their initial requirements and resubmit them, which will initiate a new development process with the new customer requirements. It should be noted that since the customer did not accept the test results, they did not receive the generated software, but they also did not incur any cost or obligation to pay for the development work that produced the software that was rejected.

If the customer accepts the test results, then the acceptance and payment component collects a payment from the customer for the software development services rendered at 702 and then returns control back to the master build component 200.

At 209, the master build component 200 then passes the compiled and packaged software, along with the packaged test results, to the product delivery component 800 at 801. The product delivery component then makes that product package available to the customer by moving it to a location where the customer can download it at 802.

The product delivery component then returns control to the master build component 200, which then concludes the development process by returning control to the network component to listen for new connections 101.

It will be appreciated that the steps and processes performed by the master build component 200 may be entirely automated such that no human intervention is required from reception of customer requirements at 103 to the placement of customer deliverables at a network location where they can be downloaded at 802.

In certain examples, the main build control component 200, network component 100, design component 300, product delivery component 800, file system component 400, source code generation component 500, code testing component 600, and/or acceptance and payment component 700 are components of a propriety software system that is used to provide the functionality discussed herein.

As will be appreciated by those skilled in the art, software (such as the propriety software discussed herein), runs on or is executed by a computer system that includes hardware resources (e.g., a CPU, memory, storage, etc. . . . )

It should be noted that the above description describes handling one customer request, but it is not meant to imply that Virtual Software Developer cannot process multiple customer requests simultaneously.

What is claimed is:

1. A method of providing software development services online that uses proprietary software to perform all of the software development work, thus fully automating the software development process and completely eliminating the human developer from the process, the method comprising the following steps:
a) The proprietary software, running on network-accessible computers, receives as input, information that defines for the proprietary software the nature of custom source code or software to be developed (a.k.a requirements);
b) The proprietary software evaluates the requirements it received and then adds any additional system requirements that it's analysis of the customer business requirements determines are needed;
c) The proprietary software determines an appropriate design for the software that is to be developed, based on the information contained in the enhanced requirements;
d) The proprietary software creates a set of detailed build instructions from the design and enhanced requirements;
e) The proprietary software uses the information in the detailed build instructions to create the hierarchy of directories that will hold the generated build files and source code commonly referred to as a source tree, generates the necessary build and configuration files, and then populates the source tree with those newly generated build and configuration files;
f) The proprietary software then uses the build instructions to create (i.e. develop) the software source code that both implements the chosen design and satisfies the requirements provided as input, producing a complete set of source code including source code for tests that prove the software meets the customer's requirements. The proprietary software then compiles the source code and packages up the resulting compiled code as well as the source code. The source code that is produced by the proprietary software is considered “work made for hire”, as defined in Section 101 of the Copyright Act (title 17 of the U.S. Code), and the intellectual property rights associated with that generated source code produced by the proprietary software will be assigned to the customer who commissioned the work;
g) The next step in the process is for the proprietary software to take the compiled output produced in previous step and to install that compiled source code on to one of the computers that the proprietary software is already running on, so that the test code that were created to test the custom software can be run to prove that the developed software satisfies the requirements that were provided by the customer as input to the development process, saving all relevant output;
h) The next step is for the proprietary software to present the test results to the customer for approval. If the customer approves the test results then the proprietary software moves on to the next step in the process. If the customer does not approve the test results, then the development process stops and all generated source code and other output from the process is deleted; and
i) The next step in the process is for the proprietary software to collect payment from, or otherwise charge the customer for the software services that were rendered and to move the developed software, including the results of the tests that were run against that software, and any other deliverables to a server where the customer can then download it.

2. The method of claim 1, wherein the customer first registers with the proprietary software running on network-accessible computers to gain access to a website and the network-accessible computers running the proprietary software.

3. The method of claim 1, wherein the requirements that define the software or source code to be developed, include at least one of databases, SOAP servers, custom built remote servers, application specific business logic and/or implementation specific information.

4. The method of claim 1, wherein the website and network-accessible computers running the proprietary software enable the saving and amending of a definition of software or source code to be developed.

5. The method of claim 1, wherein the proprietary software charges a fee for the software development services which must be paid before the developed custom software can be downloaded.

6. The method of claim 2, wherein the proprietary software can restrict the ability to download the developed software to a specific set of one or more predefined customers.
